(19) United States
(12) Patent Application Publication
(10) Pub. No.: US 2003/0034616 A1
(43) Pub. Date: Feb. 20, 2003

(54) Motor cover with integral seal

(76) Inventors: Stanley F. Deforest, Rochester, NY (US); Peter J. Danish, Scottsville, NY (US); Frank R. Lombardo, Rochester, NY (US)

Correspondence Address: ATTN: Andrew R. Basile, YOUNG & BASILE, P.C., SUITE 624, 3001 WEST BIG BEAVER ROAD, TROY, MI, 48084-3107, US

(21) Appl. No.: 10/185,803

(22) Filed: Jun. 27, 2002

Related U.S. Application Data
(63) Continuation of application No. 09/628,910, filed on Jul. 31, 2000, now abandoned.

(51) Int. Cl. F16J 15/02

(52) U.S. Cl. 277/628

(57) ABSTRACT

A motor housing assembly includes a gearbox and a gearbox cover having a resilient elastomeric seal overmolded directly onto the cover. The substrate material of the first surface and the elastomeric material of the seal are molecularly compatible such that they will chemically bond at the molecular level, resulting in a fused, single-piece seal-substrate assembly.

### FIELD OF THE INVENTION

The present invention relates to a fractional horsepower electric motor assembly, and more specifically to a motor assembly gearbox housing cover with an integrally molded seal chemically bonded to the cover.

### BACKGROUND OF THE INVENTION

Fractional horsepower electric motors are used in numerous automotive applications. For example, electric motors are used in automotive seat adjustment mechanisms, side-view mirror adjustment assemblies, and windshield wiper control mechanisms.

In the last several years, significant engineering effort has been expended on reducing the cost, and increasing the reliability of fractional horsepower electric motors used in automotive applications. One way to reduce the cost is to eliminate as many separate components as possible. Further, one way to increase motor reliability is to reduce or eliminate the potential for moisture to enter the motor assembly.

As noted above, consistent, reliable motor performance requires that the motor assembly be isolated within a watertight housing. In a standard motor assembly, a motor, including electrical brushes, a commutator, and magnets, is located in a motor housing. The motor housing is attached to a gearbox housing that contains at least one gear driven by the motor. The gearbox housing includes an opening for accessing the driven gear that is sealed with a gearbox cover. The interface between the gearbox cover and the gearbox housing is a primary entry pathway for moisture. Conventionally, a deformable seal, such as a gasket, is interposed and compressed between the gearbox and the cover to prevent ingress of moisture when the cover is attached to the gearbox housing. However, the gearbox opening, as well as the gearbox, may be formed in an irregular and oftentimes complex shape, usually including many sharp corners. As a result, orings typically cannot be used to seal the gearbox opening.

Instead, a prefabricated gasket is usually mated to the outer perimeter of the gearbox cover and is sandwiched between the cover and the gearbox to prevent moisture entry into the gearbox. However, prefabricated gaskets have a tendency to shift or to curl during assembly, thereby preventing adequate leak proofing of the gearbox. Additionally, even perfect sandwiching of a prefabricated gasket between two mating surfaces inherently leaves two potential leak pathways: one between the gasket and the gearbox housing, and another between the gasket and the gearbox cover. Moreover, prefabricated gaskets also impair the production of motor assemblies because they are often attached to the housings by hand. The alignment of a flat gasket around the outer circumference of the housing can be a rate limiting step in an assembly line operation.

To overcome the problems associated with prefabricated gaskets, seals have been devised that may be mechanically attached directly to the gearbox cover prior to assembly. One example of this type of solution involves the placement of mortises along the perimeter of the gearbox cover, into which tenons attached to the seal are inserted to affix the seal around the perimeter of the gearbox cover. Attachment of the seal to the cover is accomplished either by molding the seal and cover separately and then assembling them together by inserting the seal tenons into the cover mortises, or by using an overmold and directly injecting seal material to form the seal and associated tenons on the gearbox cover. Although this seal attachment technique may adequately address production line problems of manually attaching the seal to the gearbox cover, the seal is only mechanically attached to the cover. The seal is therefore free to move laterally and to curl, thereby affecting the watertight integrity of the motor assembly. Additionally, mechanically attaching a seal to the cover using mortises and tenons actually increases the number of potential leak pathways, because each of the mortise and tenon attachment points now represents a new access point for moisture to enter the gearbox.

A final manner of affixing the seal directly to the gearbox cover involves applying a bead of adhesive sealant, such as silicone, directly to the gearbox cover and attaching the cover to the gearbox housing before the sealant hardens. However, it is very difficult to consistently place the sealant accurately, with a consistently sized bead, around the perimeter of the cover. Inconsistent sealant placement and/or variations in the amount of sealant applied may result in potential leak paths for water entry into the gearbox. Moreover, the moisture integrity depends upon the sealant adhering to surfaces of both the cover and the housing over time, the seal may become brittle and separate from either surface, thereby reducing the life of the motor.

### SUMMARY OF INVENTION

The present invention overcomes the above-described disadvantages by providing a motor housing assembly that includes a gearbox and a gearbox cover having a seal chemically bonded thereto. According to the invention, a resilient elastomeric seal is overmolded directly onto a first surface to be sealed. The substrate material of the first surface and the elastomeric material of the seal are molecularly compatible such that they will chemically bond at the molecular level. This results in a fused, single-piece seal-substrate assembly. The first surface is then matingly attached to a second surface to be sealed such that the elastomeric seal is interposed therebetween. Since the seal is chemically bonded to one surface to be sealed, one potential leak path is eliminated when the two surfaces are matingly attached.

In one embodiment, a thermoelastic resilient polymeric seal is overmolded along an outer perimeter of a gear housing cover such that the seal material chemically bonds at a molecular level with the cover material. The cover is then matingly attached to a gear housing such that the seal is interposed therebetween. Since the seal is chemically bonded to the cover, one potential leak path between the cover and the seal is entirely eliminated. Additionally, the seal may be applied to the cover at any time prior to assembly, thereby decreasing manufacturing complexity and reducing the number of parts to be assembled together.

### BRIEF DESCRIPTION OF THE DRAWINGS

A number of features and advantages of the present invention will become apparent from the detailed description of the invention that follows and from the accompanying drawings, wherein:

FIG. 1 is a partially exploded view of a fractional horsepower motor assembly;

FIG. 2 is an exploded perspective view of a prior art gearbox cover and seal;

FIG. 3 is a perspective view of a gearbox cover of the present invention including an integral chemically bonded seal;

FIG. 4 is a second perspective view of the gearbox cover and integral chemically bonded seal of the present invention.

### DETAILED DESCRIPTION OF PREFERRED EMBODIMENTS

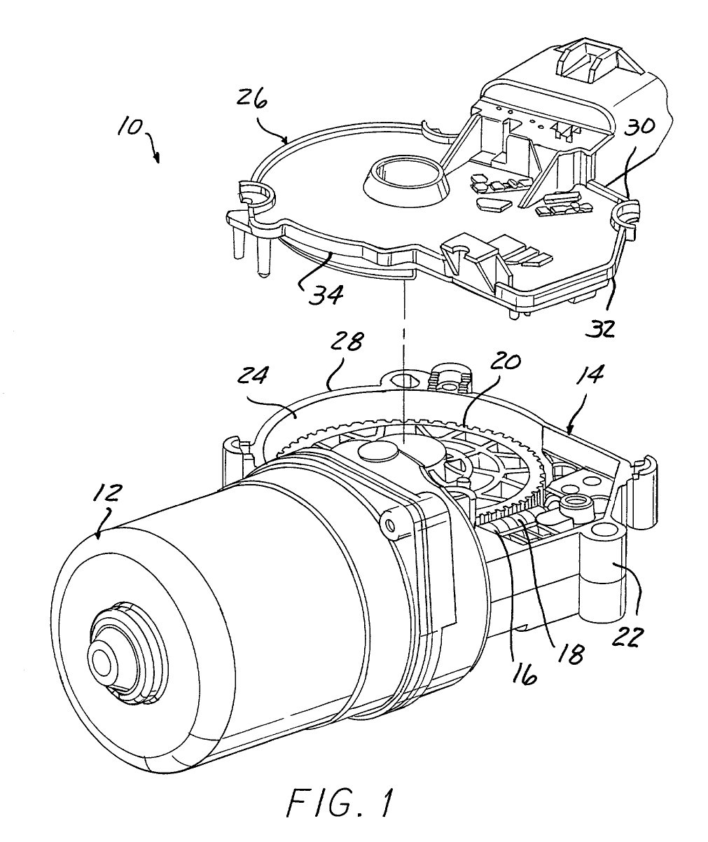

A fractional horsepower motor assembly 10 is shown in FIG. 1, including a motor assembly 12 and a gearbox assembly 14. Motor assembly 12 includes a conventional electric motor (not shown) that drives a shaft 16 terminating in a worm gear 18. When driven by shaft 16, worm gear 18 turns a gear 20 located within the gearbox assembly 14. Gear 20 may be attached to an output shaft (not shown) for driving seat adjustment mechanisms, side-view mirror adjustment mechanisms, windshield wiper control mechanisms, or the like.

Gear 20 is located within a gearbox housing 22, and is accessed through gearbox opening 24. A gearbox cover 26 is attached to the gearbox housing by conventional means to close opening 24. As may be appreciated, the size and shape of gearbox housing 22 and opening 24 are dictated by the application for which the motor assembly 10 is used, the size of gear 20 and the size of the space in which the motor assembly is to be placed. Often, the shape of gearbox opening 24 is irregular, so that a gearbox opening perimeter 28 includes sharp corners and abrupt direction changes. A corresponding cover perimeter 30 must include a flange 32 that matingly attaches to the gearbox opening perimeter 28. A seal 34 is placed between flange 32 and Perimeter 28 during mating attachment thereof to prevent moisture from entering gearbox housing 22.

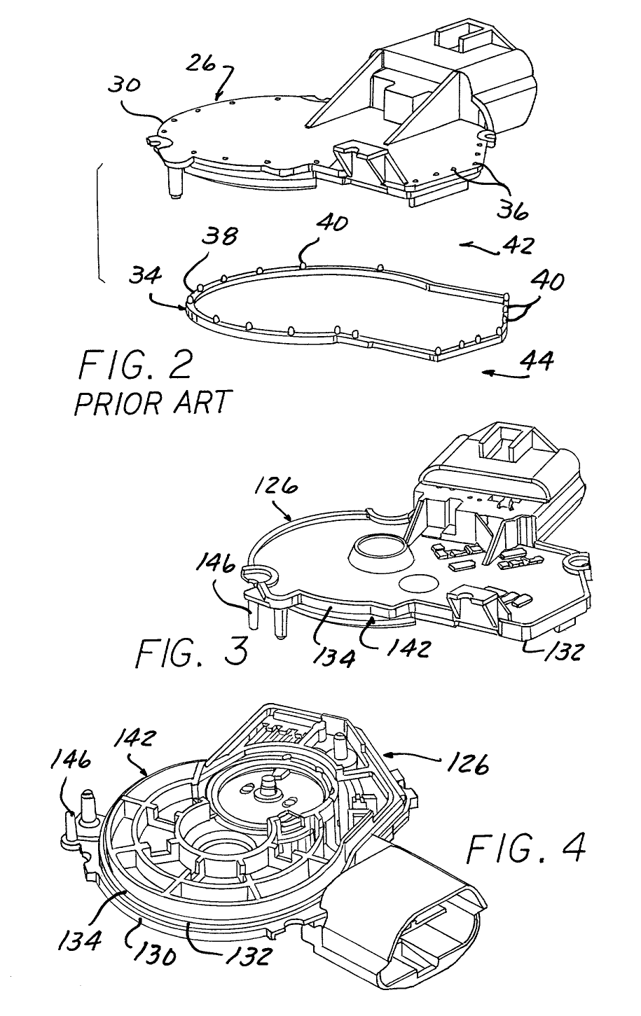

One type of prior art seal 34 is shown in FIG. 2 that mechanically attaches to gearbox cover 26. Cover 26 includes a plurality of holes or mortises 36 about cover outer perimeter 30. The seal 34, shown unattached, includes a perimeter 38 shaped to correspond to the irregular outer perimeter 30 of the gearbox cover 26. Seal 34 additionally includes a plurality of tenons 40 that correspond to the plurality of mortises 36 in gearbox cover 26. During assembly, tenons 40 are compressed into mortises 36, thereby affixing seal 34 in place. An equivalent assembly would result if seal 34 were overmolded directly onto the gearbox cover 26 such that seal material filled mortises 36. In either case, seal 34 is mechanically affixed to cover 26. The seal is therefore free to move laterally and to curl, thereby affecting the watertight integrity of the motor assembly.: The resultant assembly allows for potential moisture entry into the gearbox assembly along the mated surfaces of the gearbox housing and gearbox cover in two ways. First, moisture may enter along a junction between seal 34 and gearbox cover 26, indicated by arrow 42. Second, moisture may enter along a junction between seal 34 and the gearbox housing (not shown in FIG. 2), indicated by arrow 44. Further, mechanically attaching a seal to a cover using mortises and tenons actually increases the number of potential leak pathways, because each of the mortise and tenon attachment points is a further access point for moisture to bypass the seal.

A seal 134 formed according to the present invention is shown in FIGS. 3 and 4 that addresses the problems of prior art seals 34. Gearbox cover 126 is formed of a first material, and defines an irregularly shaped outer perimeter 130 that corresponds to a gearbox opening outer perimeter (not shown). Perimeter 130 includes a flange 132 shaped to matingly and facingly attach to the gearbox opening. Seal 134 is integrally formed on flange 132 by injection overmolding a second material such that a portion of seal 134 chemically bonds to a portion of flange 132 around the entire cover perimeter 130. Importantly, seal 134 chemically bonds to flange 132 at a molecular level because the first and second materials are molecularly compatible with each other. Thus, seal 134 and cover 126 may be formed from any combination of molecularly compatible materials, and may even be formed of the same material.

Preferably, cover 126 is injection molded from a polybutylene terepthalate/polycarbonate (“PBT/PC”) copolymer, a preferred species of which is available as “Arnite TV4 640” from DSM Engineering Plastics of Evansville, Ind. The entire gearbox may be formed of the PBT/PC copolymer, but such a construction is not essential. After forming cover 126, the PBT/PC copolymer cover is then fitted with an overmold, and seal material is injected at high temperature through injection point 146. Injection point 146 may be anywhere along perimeter 130, so long as the material is allowed to flow onto flange 132. In the preferred embodiment, seal 134 is formed from a thermoplastic elastomer such as “Tekbond 6000-45”, a thermoplastic styrene ethylene butylene styrene block copolymer manufactured by Teknor Apex of Pawtucket, R.I. This seal material is molecularly compatible with the preferred cover material such that the seal and the cover chemically bond at the molecular level during the overmolding process. This molecular bonding results in a single piece substrate-seal assembly, wherein seal 134 is continuous and seamless with gearbox cover 126. This assembly thus eliminates one of the potential leak pathways, specifically the junction between the seal and the gearbox, indicated by arrow 142, without introducing any additional potential leak pathways into the motor assembly.

Furthermore, because it is necessary to retain at least one detachable junction to accommodate repair technician access to the gearbox, the present invention produces motor assemblies having the lowest possible number of leak pathways (i.e. one), ensuring consistent and reliably watertight assemblies.

Although certain preferred embodiments of the present invention have been described, the invention is not limited to the illustrations described and shown herein, which are deemed to be merely illustrative of the best modes of carrying out the invention. A person of ordinary skill in the art will realize that certain modifications will come within the teachings of this invention and that such modifications are within its spirit and the scope as defined by the claims.

What is claimed is:

1. A gearbox assembly comprising:
a gearbox cover formed of a first material; and
an integral perimeter seal formed of a second material and molded to said gearbox cover, wherein said first and second materials are molecularly compatible such that a chemical bond forms between said seal and said cover.

2. The assembly of claim 1, wherein said gearbox cover is formed from a PPC/PT copolymer.

3. The gearbox assembly of claim 2 wherein said PBT/PC copolymer is Arnite TV4 640.

4. The gearbox assembly of claim 1 wherein said perimeter seal is formed of a thermoplastic elastomer.

5. The gearbox assembly of claim 4 wherein said thermoplastic elastomer is Tekbond 6000-45.

6. In an assembly having an opening defining a sealing perimeter, a cover for the opening, comprising:
a flange defining a cover outer perimeter corresponding to the sealing perimeter, said flange formed of a first material; and
an integral perimeter seal molded on said flange, said seal formed of a second material molecularly compatible with said first material such that a chemical bond forms between said seal and said cover.

7. The cover of claim 6, wherein said first material is a PBT/PC copolymer.

8. The cover of claim 7, wherein said first material is Arnite TV4 640.

9. The cover of claim 8, wherein said second material is Tekbond 6000-45.

10. A method for forming a seal on a gearbox cover for sealing between the cover and a gearbox opening, comprising
injection molding the cover from a first material, the cover defining a cover perimeter corresponding to a gearbox opening sealing perimeter;
inserting the cover into an overmold;
injection molding a seal formed from a second material on said cover perimeter that is molecularly compatible with said first material such that a chemical bond forms between said seal and said cover perimeter.

11. The method of claim 10 wherein said first material is a PBT/PC copolymer.

12. The method of claim 11 wherein said first material is Arnite TV4 640.

13. The method of claim 12 wherein said second material is Tekbond 6000-45.
